(19) United States
(12) Patent Application Publication
(10) Pub. No.: US 2026/0178856 A1
(43) Pub. Date: Jun. 25, 2026

(54) METHOD AND SYSTEM FOR PERFORMING INSTRUCTION TUNING BY USING HETEROGENEOUS LANGUAGES

(71) Applicant: LG MANAGEMENT DEVELOPMENT INSTITUTE CO., LTD., Seoul (KR)

(72) Inventors: Chang Ho LEE, Seoul (KR); Jang Hoon HAN, Seoul (KR); Joong Bo SHIN, Seoul (KR); Nak Yeong YANG, Seoul (KR)

(21) Appl. No.: 19/541,383

(22) Filed: Feb. 16, 2026

Related U.S. Application Data
(63) Continuation of application No. PCT/KR2025/003691, filed on Mar. 24, 2025.

(30) Foreign Application Priority Data
Mar. 22, 2024 (KR) 10-2024-0039844

(51) Int. Cl. G06F 40/58; G06N 20/00

(52) U.S. Cl. CPC G06F 40/58; G06N 20/00

(57) ABSTRACT

A method and system perform operations comprising: setting a first instruction tuning dataset comprising tasks in a first language; setting a second instruction tuning dataset comprising tasks in a second language; generating a first instruction, written in a same language as the first language, for the first instruction tuning dataset, and storing the first instruction for the first instruction tuning dataset; generating a second instruction, written in a same language as the second language, for the second instruction tuning dataset, and storing the first instruction for the first instruction tuning dataset; generating a cross-language instruction based on the first instruction tuning dataset, the first instruction for the first instruction tuning dataset, the second instruction tuning dataset, and the second instruction for the second instruction tuning dataset; and performing instruction tuning for an artificial intelligence model using the cross-language instruction.

### CROSS-REFERENCE TO RELATED APPLICATIONS

This application is a continuation of International Patent Application No. PCT/KR2025/003691, filed on Mar. 24, 2025, which claims the benefit of and priority to Korean Patent Application No. 10-2024-0039844, filed on Mar. 22, 2024, the entire disclosures of which are hereby incorporated herein by reference in their entireties.

### BACKGROUND

### Technical Field

The present disclosure generally relates to a method and system for performing instruction tuning using heterogeneous languages. More specifically, some embodiments of the present disclosure relate to a method and system for performing instruction tuning using heterogeneous languages, which may improve instruction tuning performance for different heterogeneous languages.

### Related Art

With the recent emergence of pre-trained language models, such as large language models (LLMs) trained large-scale general domain data, various tasks that were previously handled manually are now being replaced by artificial intelligence-based technologies.

As super-large language models such as Chat GPT, Google's Gemini, Naver's HyperClova, Kakao Brain's KoGPT, and LG's EXAONE are developed, various methods to increase zero-shot performance of super-large language models are being studied.

In particular, among the methods to increase the zero-shot performance of super-large language models, research on instruction tuning techniques is actively underway. The instruction tuning may be a learning method first announced in Google's Finetuned Language Models are Zero-Shot Learners (FLAN) thesis, and may refer to a technique that fine-tunes a large language model (LLM) using an instruction tuning dataset to increase the zero-shot performance.

The instruction tuning may be a technique in which a super-large language model learns to understand and perform multiple tasks by following natural-language instructions, without requiring task-specific retaining when instructions for a new task are provided.

However, the instruction tuning may require a variety of pieces of task data together with a variety of instructions to be constructed, resulting in significant time and cost overhead for resource creation.

### SUMMARY

An embodiment of the present disclosure provides a method and system for performing instruction tuning using heterogeneous languages to reduce the cost and time required for constructing resources for the instruction tuning.

In addition, an embodiment of the present disclosure provides a method and system for performing instruction tuning using heterogeneous languages to increase zero-shot performance of a super-large language model by the instruction tuning using the heterogeneous languages.

However, the technical aspects to be achieved by the present disclosure are not limited to those as described above, and other technical aspects are provided below.

A computer-implemented method according to an embodiment of the present disclosure includes: setting a first instruction tuning dataset including one or more tasks; setting a second instruction tuning dataset including one or more tasks formed in a language different from a language of the task included in the first instruction tuning dataset; generating at least one first instruction written in the same language as the language of the task included in the first instruction tuning dataset for the first instruction tuning dataset and storing the same in at least one memory; generating at least one second instruction written in the same language as the language of the task included in the second instruction tuning dataset for the second instruction tuning dataset and storing the same in at least one memory; generating, by at least one processor, a cross-language instruction based on the first instruction tuning dataset, the at least one first instruction, the second instruction tuning dataset, and the at least one second instruction; and performing instruction tuning for at least one artificial intelligence model using the cross-language instructions.

In another aspect, the generating the cross-language instruction comprises: applying the at least one first instruction to the second instruction tuning dataset; and applying the at least one second instruction to the first instruction tuning dataset.

In another aspect, the performing the instruction tuning comprises: inputting the at least one first instruction and the second instruction tuning dataset to the at least one artificial intelligence model; and inputting the at least one second instruction and the first instruction tuning dataset to the at least one artificial intelligence model.

In another aspect, the at least one first instruction and the at least one second instruction have the same format.

In another aspect, the at least one first instruction and the at least one second instruction instruct to perform the same task.

In another aspect, the setting of the first instruction tuning dataset includes generating N or more preset tasks, where the N is a natural number greater than or equal to 1.

In another aspect, the generating the at least one first instruction and the storing the same in the at least one memory includes generating 3N first instructions by generating three instructions per task.

In another aspect, the setting the first instruction tuning dataset includes generating 34 NLU (natural language understanding) tasks and 17 NLG (natural language generation) tasks based on data collected from one or more of AIHub1, KorPora2, GIthub, Huggingface, KLUE3, Korquad4, ETRI5, Modu's Corpus, and KoBest.

In another aspect, the at least one artificial intelligence model comprises a multi-lingual model.

A computer-implemented method according to an embodiment of the present disclosure includes: storing user input data related to at least one task input through a user interface in at least one memory; storing at least one instruction, which instructs to perform a task related to the user input data input through the user interface, in the at least one memory; generating, by at least one processor, output data based on the at least one instruction and the user input data using at least one artificial intelligence model, the at least one artificial intelligence model comprising a multi-lingual model pretrained through cross-language instruction tuning; and ingesting the output data to at least one subsequent processing component.

In another aspect, the method further comprises by the at least one subsequent processing component, the output data through at least one user interface.

In another aspect, the cross-language instruction tuning is performed by: setting an instruction tuning dataset comprising one or more tasks formed in a first language; generating the at least one instruction written in a second language different from the first language for the instruction tuning dataset and storing the same in the at least one memory; generating, by the at least one processor, a cross-language instruction based on the instruction tuning dataset and the at least one instruction; and performing instruction tuning for the at least one artificial intelligence model using the cross-language instruction.

A system according to an embodiment of the present disclosure comprising: at least one memory; and at least one processor for executing an instruction-based language inference method by reading out at least one instruction stored in the at least one memory, wherein the at least one instruction comprises: storing user input data related to at least one task input through a user interface in the at least one memory; storing at least one instruction, which instructs to perform a task related to the user input data input through the user interface, in the at least one memory; generating, by the at least one processor, output data based on the at least one instruction and the user input data using at least one artificial intelligence model, the at least one artificial intelligence model comprising a multi-lingual model pretrained through cross-language instruction tuning; and inputting the output data to at least one subsequent processing component.

In another aspect, a language of the at least one instruction is different from a language of the user input data

A method and system for performing instruction tuning using heterogeneous languages according to an embodiment of the present disclosure can reduce the cost and time required for constructing resources for the instruction tuning.

In addition, a method and system for performing instruction tuning using heterogeneous languages according to an embodiment of the present disclosure can increase zero-shot performance of a super-large language model by the instruction tuning using the heterogeneous languages.

However, the benefits of the present disclosure are not limited to those mentioned above, and other benefits not mentioned may be clearly understood from the following description.

### BRIEF DESCRIPTION OF DRAWINGS

FIG. 1 illustrates a block diagram of a computing system implementing instruction tuning of a language model using heterogeneous languages according to an embodiment of the present disclosure.

FIG. 2 illustrates a block diagram of a computing device implementing instruction tuning of a language model using heterogeneous languages according to an embodiment of the present disclosure.

FIG. 3 illustrates a block diagram of a computing device implementing instruction tuning of a language model using heterogeneous languages according to an embodiment of the present disclosure.

FIG. 4 is a block diagram illustrating a system for instruction tuning of a language model using heterogeneous languages according to an embodiment of the present disclosure.

FIG. 5 is a diagram illustrating a Korean instruction tuning dataset according to an embodiment of the present disclosure.

FIG. 6 is a diagram illustrating tasks and instructions according to an embodiment of the present disclosure.

FIG. 7 is a diagram illustrating an English instruction tuning dataset according to an embodiment of the present disclosure.

FIG. 8 is a diagram illustrating a cross-language instruction according to an embodiment of the present disclosure.

FIG. 9 is a diagram illustrating a language model configured to perform instruction tuning using heterogeneous languages according to an embodiment of the present disclosure.

FIG. 10 is a performance result table of a language model according to an embodiment of the present disclosure.

FIG. 11 is a performance graph of a language model according to an embodiment of the present disclosure.

FIGS. 12 to 14 are flowcharts for illustrating a method for instruction tuning of a language model using heterogeneous languages according to an embodiment of the present disclosure.

### DETAILED DESCRIPTION OF EMBODIMENTS

Embodiments can impose various transformations that can have various embodiments, and specific embodiments illustrated in the drawings will be described in detail in the detailed description. The advantages, features and methods for achieving the same will become apparent from the following description of the embodiments given in conjunction with the accompanying drawings. However, the present disclosure is not limited to the embodiments described herein but may be embodied in many different forms. It will be understood that, although the terms “first” or “second” may be used herein to distinguish one component from another component, these components should not be limited by these terms. In addition, a singular expression includes a plural expression, unless the context clearly states otherwise. In addition, it should be understood that the terms such as “include” or “have” are merely intended to indicate that features, or components described in the specification are present, and are not intended to exclude the possibility that one or more other features, or components will be added. In addition, components in the drawings may be exaggerated or shrunk for the convenience of descriptions. For example, since the size and thickness of each element in the drawings has been arbitrarily modified for the convenience of descriptions, it should be noted that the present disclosure is not necessarily limited to what has been shown in the drawings.

Hereinafter, embodiments of the present disclosure will be described in detail with reference to appended drawings. Throughout the specification, the same or corresponding component is assigned the same reference numeral, and repeated descriptions thereof will be omitted.

Hereinafter, a system for implementing instruction tuning of a language model (e.g. a large language model, LLM) using different heterogeneous languages according to some exemplary embodiments of the present disclosure is described in detail with reference to the attached drawings.

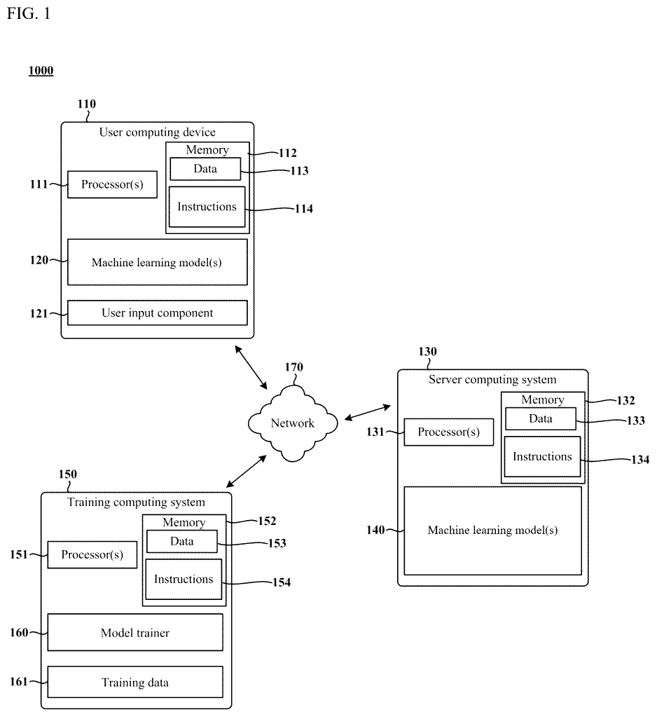

FIG. 1 illustrates a block diagram of a computing system implementing instruction tuning of a language model using heterogeneous languages according to an embodiment of the present disclosure.

Referring to FIG. 1, a computing system or computer 1000 which implements the instruction tuning of a language model using heterogeneous languages according to an embodiment of the present disclosure includes a user computing device or user computer 110, a server computing system or server 130, and a training computing system or training computer 150, and any other devices which are configured to communicate through a network 170.

A method of performing instruction-tuning on a language model using heterogeneous languages according to an embodiment of the present disclosure may be implemented and provided locally by the user computing device 110, implemented and provided in the form of a web service by the server computing system 130 which communicates with the user computing device 110, and implemented and provided by association or combination of the user computing device 110 and the server computing system 130.

In an embodiment, the user computing device 110 and/or the server computing system 130 may train a language model 120 and/or 140 (machine learning model) through interaction with the training computing system 150 communicationally connected through the network 170. The training computing system 150 may be a system separated from the server computing system 130 or may be included in or a portion of the server computing system 130.

In addition, the artificial intelligence model (e.g., a language model) may be directly trained locally by the user computing device 110, trained while the server computing system 130 and the user computing device 110 interact with each other through the network 170, and trained by using various training techniques and learning techniques by the separate training computing system 150. In addition, the artificial intelligence model trained by the training computing system 150 may be transmitted to the user computing device 110 and/or the server computing system 130 through the network 170, and is updated by the user computing device 110 and/or the server computing system 130.

In an embodiment, the training computing system 150 may be included in or a portion of the server computing system 130 included in or a portion of the user computing device 110.

The user computing device 110 may include various types of computing devices or computers such as a smart phone, a cellular phone, a digital broadcasting device, personal digital assistants (PDA), a portable multimedia player (PMP), a desktop, a wearable device, an embedded computing device, and/or a tablet personal computer (PC).

The user computing device 110 includes one or more processors 111 and one or more memories 112. The processor 110 may be configured of one or the plurality of processors electrically or communicationally connected and may include, for example, but not limited to, one or more of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions.

The memory 112 may include one or more non-transitory and/or transitory computer-readable storage media, such as Random Access Memory (RAM), Read-Only Memory (ROM), Electrically Erasable Programmable Read-Only Memory (EEPROM), Erasable Programmable Read-Only Memory (EPROM), flash memory devices, or magnetic disks, and combinations thereof, and may include web storage of servers performing storage functions of the memory on the Internet. The memory 112 may store data 113 and instructions 114 which are necessary for or executable by the processor 111 to perform a functional operation, such as training the artificial intelligence model or executing outlier detection through the artificial intelligence model.

In an embodiment, the user computing device 110 may store at least one machine learning model 120.

The machine learning model 120 may be implemented with one or more of various machine learning models such as a plurality of neural networks (for example, deep neural networks) or other types of machine learning models, including non-linear models and/or linear models, and may be configured of a combination thereof.

The neural network may include at least one of feed-forward neural networks, recurrent neural networks (for example, long short-term memory recurrent neural networks), convolutional neural networks and/or other forms of neural networks.

In an embodiment, the user computing device 110 may receive at least one machine learning model 120 from the server computing system 130 via the network 170, store the machine learning model 120 in the memory 112, and then execute the stored machine learning model 120 by the processor 111 to perform the outlier detection.

In an embodiment, the server computing system 130 may include at least one machine learning model 140 and perform operations through the machine learning model 140, and may provide a language model that has performed instruction tuning using heterogeneous languages to a user in association with the user computing device 110 in a manner of communicating data with the user computing device 110.

For example, the user computing device 110 may provide the language model that has performed the instruction tuning by providing an output for the input of a user using the machine learning model 140 through the server computing system 130 via the web.

In addition, the artificial intelligence model may also be implemented in such a way that at least some of the machine learning models 120 and/or 140 are executed on the user computing device 110 and the rest of the machine learning models 120 and/or 140 are executed on the server computing system 130.

In addition, the user computing device 110 may include at least one input component 121 configured to detect user input. For example, the user input component 121 may include a touch sensor (for example, a touch screen and/or a touch pad) that detects touch of an input medium of a user (for example, a finger or a stylus), an image sensor that detects a motion input of a user, a microphone that detects user voice input, a button, a mouse and/or a keyboard. In addition, the user input component 121 may include an interface and may receive input from an external controller (for example, a mouse or a keyboard) through the interface.

The server computing system 130 includes at least one processor 131 and a memory 132. The processor 131 may be configured of at least one or a plurality of processors electrically or communicationally connected and may include, for example, but not limited to, one or more of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions.

The memory 132 may include one or more non-transitory and/or transitory computer-readable storage media, such as RAM, ROM, EEPROM, EPROM, flash memory devices, or magnetic disks, and combinations thereof. The memory 132 may store data 133 and instructions 134 which are required for or executable by the processors 131 to perform a functional operation such as the train of the artificial intelligence model or the execution of the outlier detection through the artificial intelligence model.

In an embodiment, the server computing system 130 may include one or more computing devices or computers. For example, the server computing system 130 may be implemented so that a plurality of computing devices operate according to sequential computing architecture, parallel computing architecture, or a combination thereof. Further, the server computing system 130 may include a plurality of computing devices connected through the network 170.

Further, the server computing device 130 may store one or more machine learning models 140. For example, the server computing system 130 may include a neural network and/or multilayer non-linear model as the machine learning model 140. For example, a neural network may include a feed-forward neural network, a deep neural network, a recurrent neural network, and a convolution neural network.

The training computing system 150 includes at least one processor 151 and a memory 152. The processor 151 may be configured of at least one or a plurality of processors electrically or communicationally connected, and the processor 151 may comprise, for example, but not limited to, one or more of the CPU, the GPU, the ASICs, the DSPs, the DSPDs, the PLDs, the FPGAs, controllers, micro-controllers, microprocessors, and/or other electrical units for performing functions.

In addition, the memory 152 may include one or more non-transitory and/or transitory computer-readable storage media, such as RAM, ROM, EEPROM, EPROM, flash memory devices, or magnetic disks, and combinations thereof, and may include web storage of servers performing storage functions of the memory on the Internet. The memory 152 may store data 153 and instructions 154 which are necessary for or executable by the processor 151 to perform training of the artificial intelligence model.

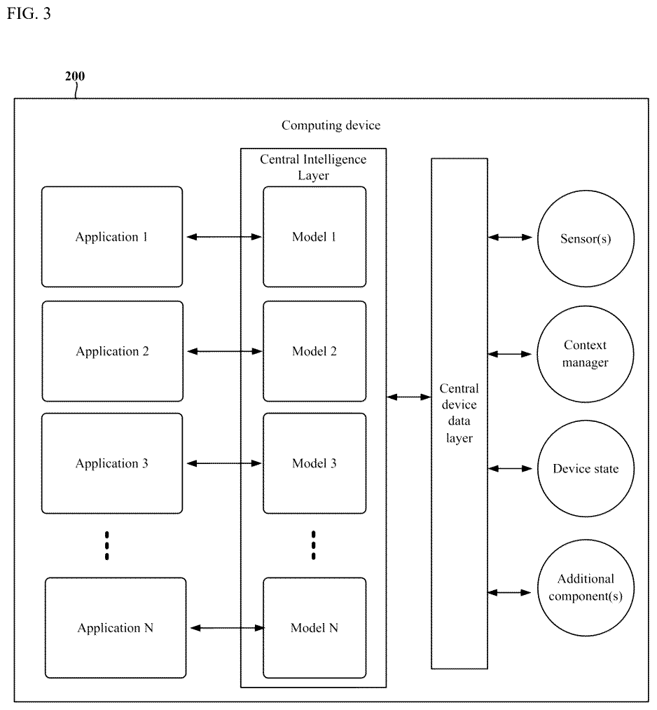

For example, the training computing system 150 may include a model trainer 160 configured to train the machine learning models 120 and/or 140 stored in the user computing device 110 and/or the server computing system 130 by using various training or learning techniques such as backpropagation of an error (according to the framework illustrated in FIG. 3).

For example, the model trainer 160 may update one or more parameters of the machine learning models 120 and/or 140 based on a defined loss function by a backpropagation scheme.

In some embodiments, the performance of the backpropagation of the error may include performing truncated backpropagation through time. The model trainer 160 may perform multiple generalization techniques (for example, weight reduction, drop-out, and/or knowledge distillation) in order to enhance a generalization capability of the trained machine learning models 120 and/or 140.

In particular, the model trainer 160 may train the machine learning models 120 and/or 140 based on a series of training data 161. The training data 161 may include, for example, different formats of data such as an image, an audio, and/or text. Examples of image type data which may be used may include a video frame, LiDAR point cloud, an X-ray image, a computer tomography scan, a hyperspectral image, and/or various other types of images.

The training data 161 may be provided by the user computing device 110 and/or the server computing system 130. When the training computing device 150 trains the machine learning models 120 and/or 140 with respect to specific data of the user computing device 110, the machine learning models 120 and/or 140 may be characterized as a personalized model.

In addition, the model trainer 160 includes a computer logic utilized to provide a desired function.

Further, the model trainer 160 may be implemented as hardware, firmware, and/or software controlling a universal processor. In one embodiment, the model trainer 160 may include a program file stored in a storage device, and may be loaded to the memory 152 and executed by one or more processors 151. In another embodiment, the model trainer 160 includes one or more sets of computer-executable data 153 and instructions 154 stored in a tangible computer-readable storage medium such as a RAM hard disk or an optical or magnetic medium.

The network 170 includes a 3rd Generation Partnership Project (3GPP) network, a Long Term Evolution (LTE) network, a World Interoperability for Microwave Access (WIMAX) network, Internet, a Local Area Network (LAN), Wireless Local Area Network (LAN), a Wide Area Network (WAN), a Personal Area Network (PAN), a Bluetooth network, a satellite broadcasting network, an analog broadcasting network, and/or a Digital Multimedia Broadcasting (DMB) network, but is not limited thereto.

In general, communication through the network 170 may be performed through various communication protocols (for example, TCP/IP, HTTP, SMTP, and/or FTP), encoding or formats (for example, HTML and/or XML), and/or protective schemas (for example, VPN, secure HTTP, and/or SSL) by using any type of wired and/or wireless communication.

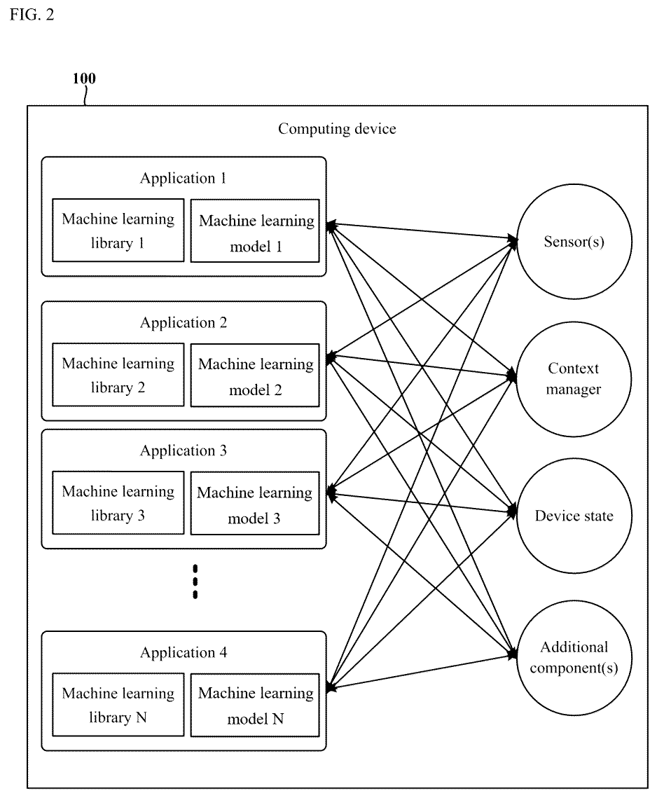

FIG. 2 illustrates a block diagram of a computing device implementing instruction tuning of a language model using heterogeneous languages according to an embodiment of the present disclosure.

Referring to FIG. 2, a computing device 100 included in the user computing device 110, the server computing system 130, and/or the training computing system 150 includes a plurality of applications (for example, application 1 to application N). Each application may include a machine learning library and at least one machine learning model. For example, the applications may include a language processing application, a text messaging application, an e-mail application, a dictation application, a virtual keyboard application, a browser application, and a chat-bot application.

In an embodiment, the computing device 100 may include the model trainer 160 for training the artificial intelligence model, and may store and operate the trained artificial intelligence model to provide output data according to predetermined input data (in an embodiment, image data).

Each application of the computing device 100 may communicate with another or other components of the computing device 100, such as, one or more sensors, a context manager, a device state component, and/or additional components. Each application may communicate with each device component using an Application Programming Interface (API) (for example, a public API). In addition, the API used by each application may be specific to a relevant application.

FIG. 3 illustrates a block diagram of a computing device 1000 implementing instruction tuning of a language model using heterogeneous languages according to an embodiment of the present disclosure.

Referring to FIG. 3, a computing device 300 includes a plurality of applications (for example, application 1 to application N). Each application is in communication with a central intelligence layer. For example, the applications may include a language processing application, a text messaging application, an e-mail application, a dictation application, a virtual keyboard application, and a browser application. Each application may communicate with the central intelligence layer (e.g., model(s) stored therein) using an API (for example, a common API across all applications).

In addition, the central intelligence layer may include a plurality of machine learning models. For example, as illustrated in FIG. 3, a respective machine learning model or at least some of machine learning models may be provided for each application and managed by the central intelligence layer. In other implementations, two or more applications may share a single machine leaning model. For example, in some implementations, the central intelligence layer may provide a single model for all of the applications. In other implementations, the central intelligence layer may be included in an operating system of the computing device 300 or implemented differently.

The central intelligence layer may communicate with a central device data layer. The central device data layer may be a centralized data storage for the computing device 300. As illustrated in FIG. 3, the central device data layer may communicate with another or other components of the computing device 300, such as, for example, one or more sensors, a context manager, a device state component, and/or additional components. In some implementations, the central device data layer may communicate with each device component using an API (for example, a private API).

The technologies and components discussed herein may be applied and make reference to servers, databases, software applications, and other computer-based systems, as well as actions taken and information sent to and from systems. The inherent flexibility of computer-based systems allows for a great variety of possible configurations, combinations, and divisions of tasks and functionality between and among components. For instance, processes discussed herein may be implemented using a single device or component or a plurality of devices or components working in combination. Databases and applications may be implemented on a single system or distributed across a plurality of systems. Distributed components may operate sequentially or in parallel.

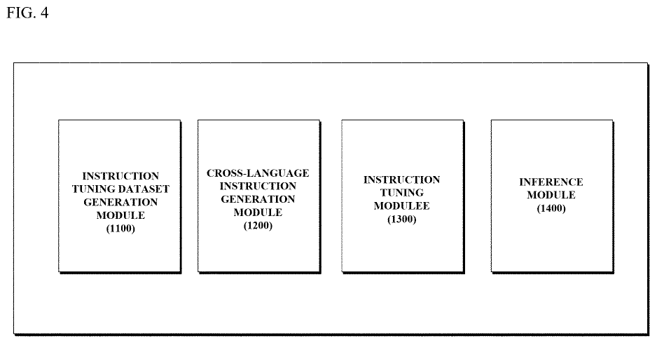

Hereinafter, with reference to FIG. 4, a system for performing instruction tuning on a language model using heterogeneous languages according to an embodiment of the present disclosure will be described.

FIG. 4 is a block diagram illustrating an instruction tuning system of a language model using heterogeneous languages according to an embodiment of the present disclosure.

An instruction tuning system 1000 using heterogeneous languages according to an embodiment of the present disclosure may comprise a language model (LLM) that performs instruction tuning using two different languages.

The instruction tuning system 1000 using the heterogeneous languages includes a memory and a processor, at least one application is stored in the memory, and the processor reads the application stored in the memory and performs instruction tuning of a learning model using heterogeneous languages.

The function for performing the instruction tuning using the heterogeneous languages may be performed by exemplary components illustrated the block diagram of FIG. 4. Referring to FIG. 4, the processor may perform the functions of an instruction tuning dataset generation module 1100, a cross-language instruction generation module 1200, an instruction tuning module 1300, and an inference module 1400 described below.

The instruction tuning dataset generation module 1100 generates an instruction tuning dataset using data written in each language to perform instruction tuning for different languages. The instruction tuning dataset generation module 1100 may differently generate a first instruction tuning dataset for a first language and a second instruction tuning dataset for a second language.

The instruction tuning dataset generation module 1100 generates and secures various tasks using metadata and open sources to generate the first instruction tuning dataset. In addition, the instruction tuning dataset generation module 1100 sets M preset instructions (template) for each task (M is a natural number greater than or equal to 1).

For instance, M may be set to a value of 10, but the present disclosure is not limited thereto.

Specifically, the instruction tuning dataset generation module 1100 may generate and classify datasets including various open sources such as AIHub1, Korpora2, Github, Huggingface, KLUE3, Korquad4, and ETRI5 and language understanding and language generation tasks. In addition, the instruction tuning dataset generation module 1100 may configure clusters of the dataset using heuristic rules.

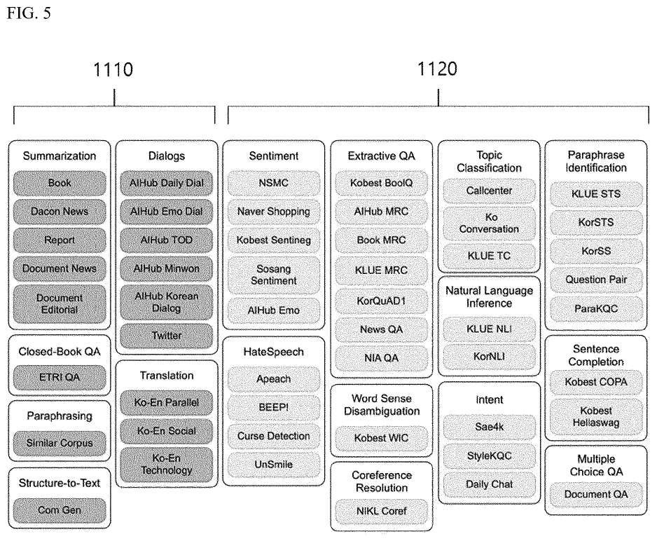

For example, the instruction tuning dataset generation module 1100 may generate the first instruction tuning dataset such that the first instruction tuning dataset is classified into a total of 17 task clusters, including 17 natural language generation (NLG) datasets 1110 and 34 natural language understanding (NLU) datasets 1120, as illustrated in FIG. 5.

In other words, Summarizaiton, Closed-Book QA, Paraphasing, Structure-to-Text, Dialogs, Translation, Sentiment, HateSpeech, Extractive QA, Word Sense Disambiguation, Coreference Resolutino, Topic Classification, Natural Language Inference, Intent, Paraphase Identification, Sentence Completion, and Multiple Choice QA illustrated in FIG. 5 represent 17 task cluster classifications.

In addition, Book, Dacon News, Report, Document News, Document Editorial, ETRI QA, Similar Corpus, Com Gen, AIHub Daily Dial, AIHub Emo Dial, AIHub TOD, AIHub Minwon, AIHub Korean Dialog, Twitter, Ko-En Parallel, Ko-En Social, and Ko-En Technology represent 17 NLG datasets, and NSMC, Naver Shopping, Kobest Sentineg, Sosang Sentiment, AIHub Emo, Apeach, BEEP!, Curse Detection, UnSmile, Kobest BooIQ, AIHub MRC, Book MRC, KLUE MRC, KorQuAD1, News QA, NIA QA, Kobeast WIC, NIKL Coref, Callcenter, Ko Conversation, KLUE TC, KLUE NLI, KorNLI, Sae4k, StyleKQC, Daily Chat, KLUE STS, KorSTS, KorSS, Question Pair, ParaKQC, Kobest COPA, Kobest Hellaswag, and Document QA refer to 34 NLU datasets.

As such, the instruction tuning dataset generation module 1100 generates various natural language processing (NLP) tasks to generate the first instruction tuning dataset, and sets M instructions for each task.

The instruction tuning dataset generation module 1100 generates an instruction by using all or some of data labels included in the first instruction tuning dataset or by adding a new data label to generate the instruction for the first instruction tuning dataset.

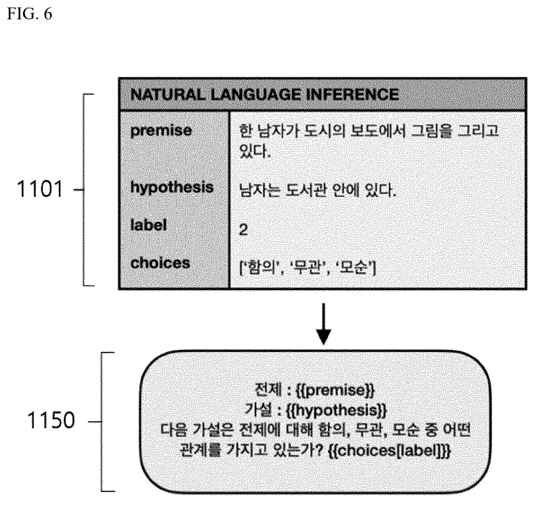

Specifically, as illustrated in FIG. 6, a task 1101 included in the first instruction tuning dataset includes a plurality of data labels and values corresponding to the data labels. The instruction tuning dataset generation module 1100 generates an instruction 1150 for the task 1101 by using all or some of the data labels included in the task 1101 or by adding one or more new data labels. The instruction 1150 generated for the task 1101 may be generated in a plurality of instances, and, for example, 10 or more instructions 1150 may be generated and set for each task 1101.

In addition, the instruction tuning dataset generation module 1100 may generate the second instruction tuning dataset written in the second language. The instruction tuning dataset generation module 1100 may generate the second instruction tuning dataset using P3 data of T0.

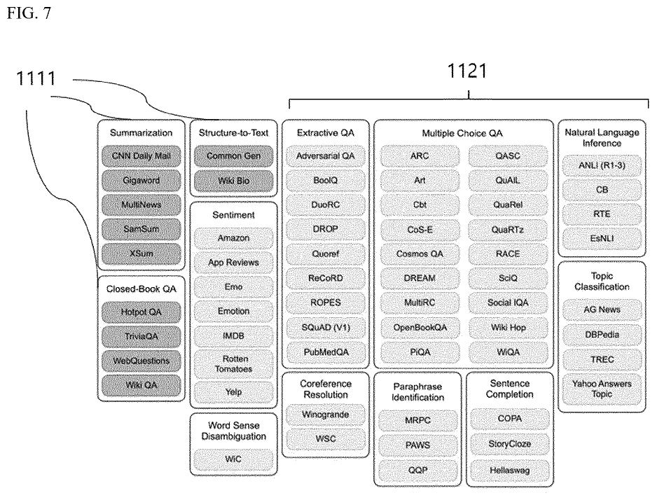

As an example, as illustrated in FIG. 7, the second instruction tuning dataset may be generated to be classified into a total of 12 task clusters, including 11 NLG datasets 1111 and 51 NLU datasets 1121.

In other words, summarization, Closed-Book QA, Structure-to-Text, Sentiment, Word Sense Disambiguation, Extractive QA, Coreference Resolution, Multiple Choice QA, Paraphrase Identification, Sentence Completion, Natural Language Inference, and Topic Classification illustrated in FIG. 7 correspond to 12 task clusters.

In addition, CNN Daily Mail, Gigaword, MutiNews, SamSum, XSum, Hotpot QA, TriviaQA, WebQuestions, Wiki QA, Common Gen, and Wiki Bio refer to 11 NLG datasets 1111, and Amazon, App Reviews, Emo, Emotion, IMDB, Rotten Tomatoes, Yelp, WIC, Adversarial QA, BooIQ, DuoRC, DROP, Quoref, ReCoRD, ROPES, SQuAD(V1), PubMedQA, Winogrande, WSC, ARC, Art, Cbt, CoS-E, Cosmos QA, DREAM, MultiRC, OpenBookQA PiQA, QASC, QuAIL, QuaRel, QuaRTz, RACE, SciQ, Social IQA, Wiki Hop, WiQA, MRPC, PAWS, QQP, COPA, StoryCloze, Hellaswag, ANLI(R1-3), CB, RTE, EsNLI, AG News, DBPedia, TREC, and Yahho Answers Topic refer to 51 NLU datasets 1121.

In addition, the instruction tuning dataset generation module 1100 may generate an instruction by using all or some of data labels included in the second instruction tuning dataset or by adding a new data label to generate the instruction for the second instruction tuning dataset.

The cross-language instruction generation module 1200 generates a cross-language instruction for performing instruction tuning of a language model using heterogeneous languages (e.g. the first language and second language).

The cross-language instruction generation module 1200 may increase the effects of instruction tuning using two languages by generating and setting N cross-language instructions (N is a natural number greater than or equal to 1) per task included in the first instruction tuning dataset and the second instruction tuning dataset.

N may be set to a value of 3, but the present disclosure is not limited thereto.

Specifically, the cross-language instruction generation module 1200 generates the first instruction written in the first language and the second instruction written in the second language. The first and second instructions are set to have the same format (data label). In addition, the first instruction is applied to the second instruction tuning dataset, and the second instruction is applied to the first instruction tuning dataset.

In other words, the dataset and instructions are configured such that the language of the instruction tuning dataset and the language of the instructions intersect with each other.

The cross-language instruction generation module 1200 may generate the first instruction by machine-translating instructions for the second instruction tuning dataset into the first language, and may generate the second instruction by machine-translating instructions for the first instruction tuning dataset into the second language.

In addition, the cross-language instruction generation module 1200 may generate the cross-language instruction by preferentially selecting commonly included data labels among the basic instructions for the first instruction tuning dataset and the data labels included in the second instruction tuning dataset.

In addition, the cross-language instruction generation module 1200 may generate the cross-language instruction by setting weights for each data label based on the frequency of use among the basic instructions for the first instruction tuning dataset and the data labels included in the second instruction tuning dataset, and adding data labels with weights greater than a reference value.

In addition, the cross-language instruction generation module 1200 adds, deletes, and modifies the data label of the first instruction and the label of the second instruction to change the format of the first instruction and the format of the second instruction to be identical.

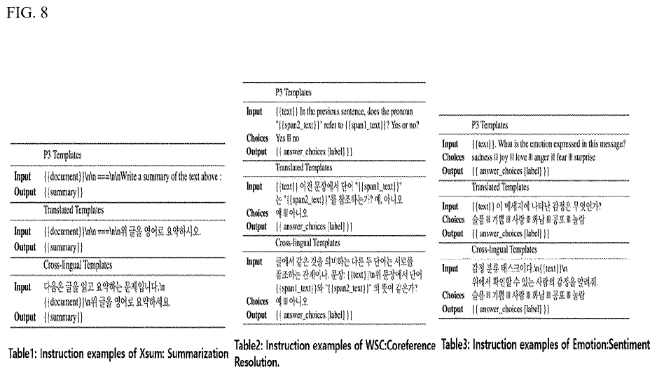

FIG. 8 is an example of a cross-language instruction.

Referring to FIG. 8, Table 1 shows examples of cross-language instructions for Xsum: Summarization, Table 2 shows examples of cross-language instructions for WSC: Coreference Resolution, and Table 3 shows examples of cross-language instructions for Emotion: Sentiment.

The P3 Template in Tables 1 to 3 refers to instructions of the second instruction tuning dataset, the Translated Template refers to instructions simply translated into the first language, and the Cross-Lingual Templates refer to cross-language instructions in which the order or position of data labels or the presence or absence of expressions are modified.

The instruction tuning module 1300 performs instruction tuning on the first instruction tuning dataset and the second instruction tuning dataset using the cross-language instruction generated by the cross-language instruction generation module 1200.

In other words, the LLM may perform learning using the cross-language instruction, the first instruction tuning dataset, and the second instruction tuning dataset.

In addition, the inference module 1400 may be used to perform inference using the cross-language instruction in an inference stage, separately from or in addition to a learning stage.

In other words, the language model may perform learning using the first instruction tuning dataset and the second instruction tuning dataset, or perform inference on newly input data using the cross-language instruction, the first instruction tuning dataset, and the second instruction tuning dataset, or perform learning and inference on new data using the cross-language instruction, the first instruction tuning dataset, and the second instruction tuning dataset.

A heterogeneous language model may be used as the language model for using the first and second languages.

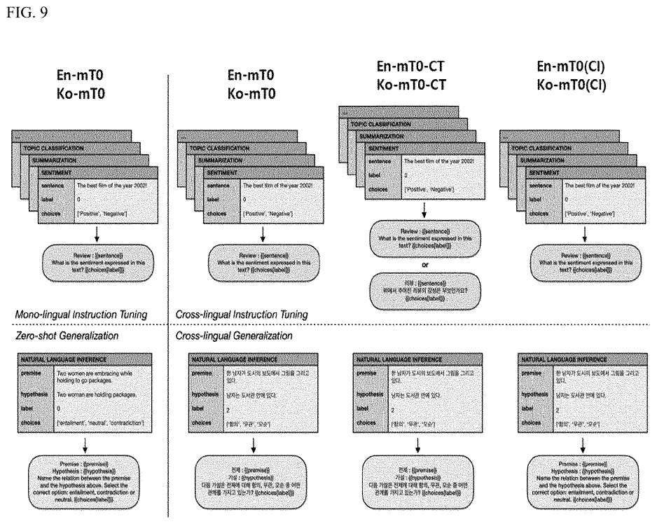

Hereinafter, with reference to FIG. 9, a language model using cross-language instructions in learning and inference stages and the performance of each model will be described.

FIG. 9 shows an example of a language model that performs learning and inference on cross-language instructions.

In FIG. 9, training and evaluation are distinguished by a dotted line, with the region above the dotted line representing training and the region below the dotted line representing evaluation. In addition, in FIG. 9, the solid line distinguishes between a single language case and a heterogenous language case, with the left side of the solid line representing a single language case and the right side of the solid line representing a heterogenous language case.

In addition, in FIG. 9, En-mT0 refers to a language model trained using the second instruction tuning dataset described above. En-mT0-CT refers to a language model that performs training on the second instruction tuning dataset using the cross-language instruction described above only during the training and performs the inference with the original instructions. En-mT0(CI) refers to a model that trains on the second instruction tuning dataset using an original instruction and performs the inference using the cross-language instruction.

In addition, Ko-mT0 refers to a language model trained using the first instruction tuning dataset described above. Ko-mT0-CT refers to a language model that performs training on the first instruction tuning dataset using the cross-language instruction described above only during the training and performs the inference with the original instructions. Ko-mT0(CI) refers to a model that performs training on the first instruction tuning dataset using the original instructions and performs the inference using the cross-language instruction.

The examples described in the present disclosure are explained assuming that the first language is Korean and the second language is English for illustration purposes only, but the present disclosure is not limited thereto.

To evaluate the zero-shot performance of each model for the task, evaluations were performed using two separate holdout setups. The first group includes four tasks: natural language inference, sentence completion, coreference resolution, and word sense disambiguation. The second group is configured of three tasks: sentiment analysis, summarization, and multiple-choice QA.

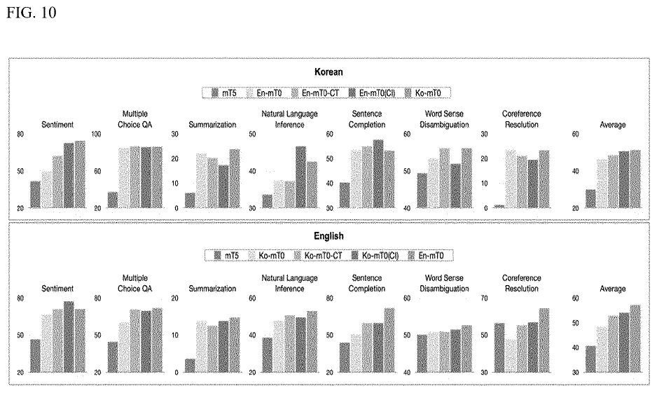

FIG. 10 shows zero-shot performance scores and language generalization performance scores of each model.

As illustrated in FIG. 10, performance improvements occurred even when instruction tuning was applied in two different languages. Specifically, tasks such as multiple-choice QA, summarization, and sentence completion in Korean evaluation show similar performance between an En-mT0 model and a Ko-mT0 model. In addition, for English evaluation, Ko-mT0 shows similar performance to En-mT0 in sentiment analysis and summarization tasks.

In addition, CT and CI models using the cross-language instruction were found to have improved performance in most indicators compared to models using the original instructions. Specifically, in the evaluation for Korean, En-mT0-CT and En-mT0(CI) were found to show significant performance improvements compared to En-mT0. Similarly, in English evaluation, Ko-mT0-CT and Ko-mT0(CI) were found to have improved performance compared to Ko-mT0. Accordingly, when a language model is trained and inferred using cross-language instructions, the performance is improved compared to instruction tuning using a single language.

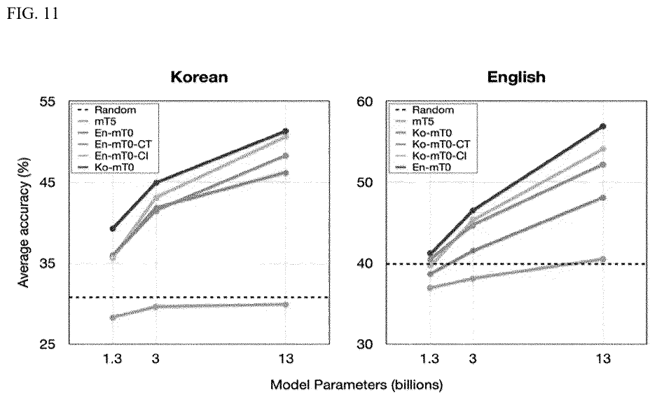

FIG. 11 is a graph illustrating the average task performance for both Korean and English. As illustrated in FIG. 11, the performance of all instruction tuning models improves as the model size increases. In addition, the models using the cross-language instruction (En-mT0-CT, En-mT0-CI, Ko-mT0-CT, and Ko-mT0-CI) across various model sizes show a greater degree of performance improvement than the general models (En-mT0 and Ko-mT0).

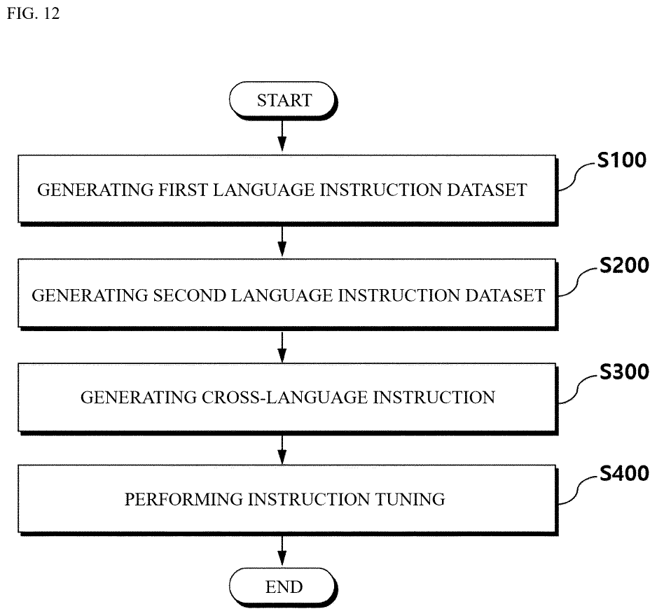

Hereinafter, a method for performing instruction tuning of a language model using heterogeneous languages according to embodiments of the present disclosure will be described in detail with reference to FIGS. 12 to 14.

FIGS. 12 to 14 are flowcharts of a method for performing instruction tuning of a language model using heterogeneous languages according to embodiments of the present disclosure.

Referring to FIG. 12, a method for performing instruction tuning of a language model using heterogeneous languages according to an embodiment of the present disclosure may include: step S100 of generating a first language instruction dataset; step S200 of generating a second language instruction dataset; step S300 of generating a cross-language instruction; and step S400 of performing instruction tuning.

In step S100 of generating the first language instruction dataset, a system for performing instruction tuning on the language model using the heterogeneous languages may generate and classify datasets including various open sources such as AIHub1, Korpora2, Github, Huggingface, KLUE3, Korquad4, and ETRI5, as well as language understanding and language generation tasks.

In addition, in step S100 of generating the first language instruction dataset, the system of performing the instruction tuning on the language model using the heterogeneous languages may configure clusters of dataset using heuristic rules.

For instance, in step S100 of generating the first language instruction dataset, the system of performing the instruction tuning on the language model using the heterogeneous languages may generate the first instruction tuning dataset so that the first instruction tuning dataset is classified into a total of 17 task clusters, including 17 NLG datasets 1110 and 34 NLU datasets 1120, as illustrated in FIG. 5.

In addition, in step S100 of generating the first language instruction dataset, the system of performing the instruction tuning on the language model using the heterogeneous languages may set a basic instruction for the first instruction tuning dataset. The basic instruction may be set using the same first language as the first instruction tuning dataset.

In addition, the basic instruction for the first instruction tuning dataset may be generated by the system for performing the instruction tuning on the language model using the heterogeneous languages by using all or some of the data labels included in the first instruction tuning dataset or by adding one or more new data labels.

In step S200 of generating the second language instruction dataset, the system for performing the instruction tuning on the language model using the heterogeneous languages may generate and set the second instruction tuning dataset and the basic instruction using P3 data.

In step S300 of generating the cross-language instruction, the system for performing the instruction tuning on the language model using the heterogeneous languages generates and sets N cross-language instructions (N is a natural number greater than or equal to 1) for each task included in the first instruction tuning dataset and the second instruction tuning dataset, thereby increasing the effect of instruction tuning using two languages.

For example, N may be set to a value of 3, but the present disclosure is not limited thereto.

Specifically, in step S300 of generating the cross-language instruction, the system for performing the instruction tuning on the language model using the heterogeneous languages generates the first instruction written in the first language and the second instruction written in the second language. The first and second instructions are set to have the same format (data label). In addition, the first instruction is applied to the second instruction tuning dataset, and the second instruction is applied to the first instruction tuning dataset.

In other words, the dataset and instruction are set so that the language of the instruction tuning dataset and the language of the instruction intersect with each other.

The system for performing the instruction tuning of the language model using the heterogeneous languages may generate the first instruction by machine translating instructions for the second instruction tuning dataset into the first language, and may generate the second instruction by machine translating instructions for the first instruction tuning dataset into the second language.

In addition, the system for performing the instruction tuning of the language model using the heterogeneous languages may generate the cross-language instruction by preferentially selecting data labels commonly included among the basic instructions for the first instruction tuning dataset and the data labels included in the second instruction tuning dataset.

In addition, the system for performing the instruction tuning of the language model using the heterogeneous languages may generate the cross-language instruction by setting weights for data labels, respectively, based on the frequency of use among the basic instructions for the first instruction tuning dataset and the data labels included in the second instruction tuning dataset, and adding data labels with weights greater than a reference value.

In addition, in step S300 of generating the cross-language instruction, the system for performing the instruction tuning of the language model using the heterogeneous languages adds, deletes, and modifies the data label of the first instruction and the label of the second instruction to change the format of the first instruction and the format of the second instruction to be identical.

In step S400 of performing the instruction tuning, the system for the instruction tuning of the language model using the heterogeneous languages performs learning or tuning of a language model (e.g., LLM, mT0) by applying the cross-language instruction to the first instruction tuning dataset and/or the second instruction tuning dataset.

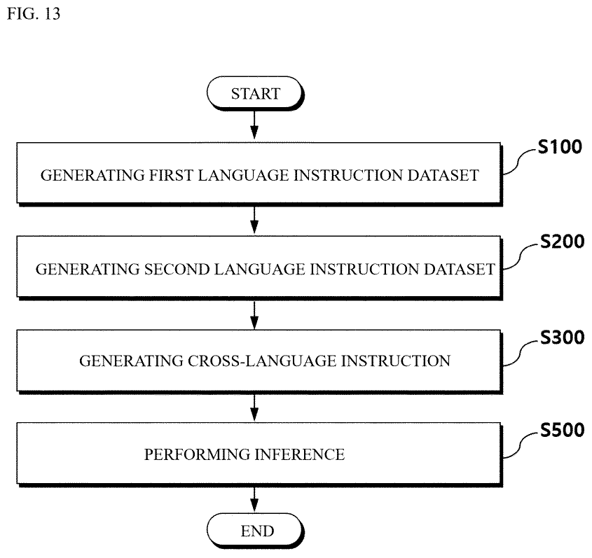

In addition, referring to FIG. 13, a method for performing instruction tuning of a language model using heterogeneous languages according to an embodiment of the present disclosure may include: step S100 of generating a first language instruction dataset; step S200 of generating a second language instruction dataset; step S300 of generating a cross-language instruction; and step S100 of performing inference.

In step S500 of the inference, the basic instructions of the first instruction tuning dataset and the second instruction tuning dataset are applied to train or tune the language model, and then in the performance of the inference of the learning model for the input data, the cross-language instruction is applied to the first instruction tuning dataset and/or the second instruction tuning dataset to perform the inference.

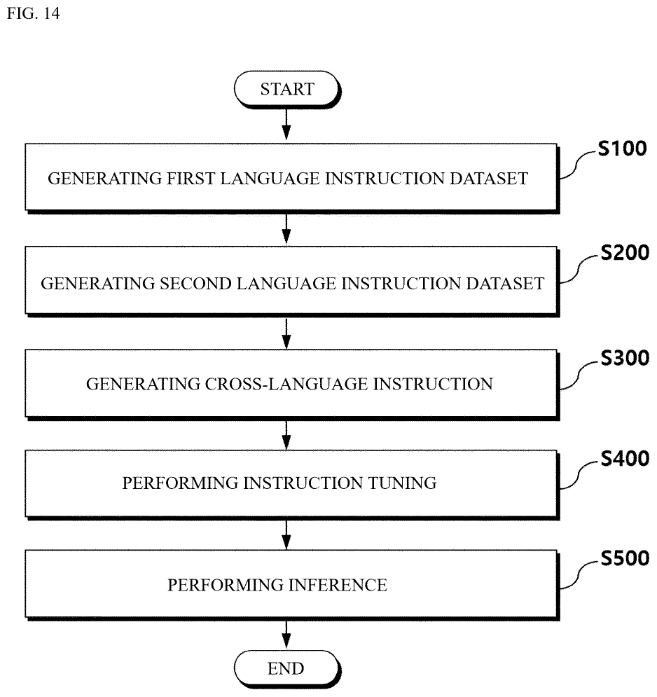

Referring to FIG. 14, a method for performing instruction tuning of a language model using heterogeneous languages according to an embodiment of the present disclosure may include: step S100 of generating a first language instruction dataset; step S200 of generating a second language instruction dataset; step S300 of generating a cross-language instruction; step S400 of performing instruction tuning or learning; and step S500 of performing inference.

In both step S400 of performing the instruction tuning or learning and step S500 performing inference of the method for performing the instruction tuning of the language model using the heterogeneous languages according to an embodiment illustrated FIG. 14, the cross-language instruction is applied to the first instruction tuning dataset and/or the second instruction tuning dataset.

Accordingly, not only is learning or tuning of a language model performed by applying the cross-language instruction to the first instruction tuning dataset and/or the second instruction tuning dataset, but inference is also performed by applying the cross-language instruction to the first instruction tuning dataset and/or the second instruction tuning dataset.

The embodiments of the present disclosure described above may be implemented in the form of program commands which may be executed through various types of computer constituting elements and recorded in a computer-readable recording medium. The computer-readable recording medium may include program commands, data files, and data structures separately or in combination thereof. The program commands recorded in the computer-readable recording medium may be those designed and configured specifically for various embodiments of the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program commands such as ROM, RAM, and flash memory. Examples of program commands include not only machine codes such as those generated by a compiler but also high-level language codes which may be executed by a computer through an interpreter and the like. The hardware device may be replaced with by one or more software modules to perform the operations of various embodiments of the present disclosure, and vice versa.

Specific executions described in the present disclosure are exemplary embodiments and the scope of various embodiments of the present disclosure is not limited even by any method. For brevity of the specification, descriptions of conventional electronic configurations, control systems, software, and other functional aspects of the systems may be omitted. Further, connection or connection members of lines among components exemplarily represent functions connections and/or physical or circuitry connections and may be represented as various functional connections, physical connections, or circuitry connections which are replaceable or added in an actual device. Further, unless otherwise specified, such as “essential” or “important,” the connections may not be components particularly required for application of various embodiments of the present disclosure.

Further, in the detailed description of the present disclosure, which is described, while the present disclosure has been described with respect to the preferred embodiments, it will be understood by those skilled in the art or those skilled in the art having ordinary knowledge in the technical field that various changes and modifications of various embodiments of the present disclosure may be made without departing from the spirit and the technical scope of the present disclosure described in the following claims. Accordingly, the technical scope of various embodiments of the present disclosure should not be limited to the contents described in the detailed description of the present disclosure but should be defined by the claims.

Some embodiments of the present disclosure relate to a method and system for performing instruction tuning using heterogeneous languages, and can be used in the artificial intelligence industry, and thus have industrial applicability.

What is claimed is:

1. A computer-implemented method comprising:
setting a first instruction tuning dataset comprising one or more tasks in a first language;
setting a second instruction tuning dataset comprising one or more tasks in a second language different from the first language;
generating at least one first instruction, written in a same language as the first language of the one or more tasks comprised in the first instruction tuning dataset, for the first instruction tuning dataset, and storing the generated at least one first instruction for the first instruction tuning dataset in at least one memory;
generating at least one second instruction, written in a same language as the second language of the one or more tasks comprised in the second instruction tuning dataset, for the second instruction tuning dataset, and storing the generated at least one first instruction for the first instruction tuning dataset in the at least one memory;
generating, by at least one processor, a cross-language instruction based on the first instruction tuning dataset comprising the one or more tasks in the first language, the at least one first instruction for the first instruction tuning dataset, the second instruction tuning dataset comprising the one or more tasks in the second language, and the at least one second instruction for the second instruction tuning dataset; and
performing instruction tuning for at least one artificial intelligence model using the cross-language instruction.

2. The computer-implemented method of claim 1, wherein the generating of the cross-language instruction comprises:
applying the at least one first instruction written in the first language to the second instruction tuning dataset comprising the one or more tasks in the second language; and
applying the at least one second instruction written in the second language to the first instruction tuning dataset comprising the one or more tasks in the first language.

3. The computer-implemented method of claim 1, wherein the performing of the instruction tuning comprises:
inputting the at least one first instruction written in the first language and the second instruction tuning dataset comprising the one or more tasks in the second language to the at least one artificial intelligence model; and
inputting the at least one second instruction written in the second language and the first instruction tuning dataset comprising the one or more tasks in the first language to the at least one artificial intelligence model.

4. The computer-implemented method of claim 1, wherein the at least one first instruction and the at least one second instruction have a same format as one another.

5. The computer-implemented method of claim 1, wherein the at least one first instruction and the at least one second instruction are configured to instruct to perform a same task as one another.

6. The computer-implemented method of claim 1, wherein the setting of the first instruction tuning dataset comprises generating N or more preset tasks, where the N is a natural number greater than or equal to 1.

7. The computer-implemented method of claim 6, wherein the generating of the at least one first instruction comprises generating 3N first instructions by generating three first instructions for each of the N or more preset tasks.

8. The computer-implemented method of claim 1, wherein the setting of the first instruction tuning dataset comprises generating a plurality of natural language understanding (NLU) tasks and a plurality of natural language generation (NLG) tasks based on data collected from one or more of a plurality of open sources.

9. The computer-implemented method of claim 1, wherein the at least one artificial intelligence model comprises a multi-lingual model.

10. A computer-implemented method comprising:
storing, in at least one memory, user input data related to at least one task and input through a user interface;
storing, in the at least one memory, at least one instruction for performing the at least one task related to the user input data input through the user interface;
generating, by at least one processor, output data based on the at least one instruction and the user input data using at least one artificial intelligence model comprising a multi-lingual model pre-trained through cross-language instruction tuning; and
ingesting the output data to at least one subsequent processing component.

11. The computer-implemented method of claim 10, further comprising manifesting, by the at least one subsequent processing component, the output data through the user interface.

12. The computer-implemented method of claim 10, wherein the cross-language instruction tuning comprises:
setting an instruction tuning dataset comprising one or more tasks in a first language;
generating the at least one instruction written in a second language different from the first language for the instruction tuning dataset, and storing, in the at least one memory, the at least one instruction written in the second language;
generating, by the at least one processor, a cross-language instruction based on the instruction tuning dataset comprising the one or more tasks in the first language and the at least one instruction written in the second language; and
performing instruction tuning for the at least one artificial intelligence model using the cross-language instruction.

13. A system comprising:
at least one memory configured to store instructions that are executable; and
at least one processor configured to execute one or more of the instructions to perform operations comprising:
storing user input data related to at least one task and input through a user interface in the at least one memory;
storing, in the at least one memory, at least one instruction for performing the at least one task related to the user input data input through the user interface;
generating output data based on the at least one instruction and the user input data using at least one artificial intelligence model comprising a multi-lingual model pre-trained through cross-language instruction tuning; and
inputting the output data to at least one subsequent processing component.

14. The system of claim 13, wherein a language of the at least one instruction is different from a language of the user input data.

15. The system of claim 13, wherein the cross-language instruction tuning comprises:
setting an instruction tuning dataset comprising one or more tasks in a first language;
generating the at least one instruction written in a second language different from the first language for the instruction tuning dataset and storing, in the at least one memory, the at least one instruction written in the second language;
generating a cross-language instruction based on the instruction tuning dataset comprising the one or more tasks in the first language and the at least one instruction written in the second language; and
performing instruction tuning for the at least one artificial intelligence model using the cross-language instruction.
